(19) United States
(12) Patent Application Publication
(10) Pub. No.: US 2018/0225744 A1
(43) Pub. Date: Aug. 9, 2018

(54) In-Store Display with Selective Display of Products Based on Visibility Metric

(71) Applicant: Shopper Scientist LLC, Corbett, OR (US)

(72) Inventor: Herb Sorensen, Corbett, OR (US)

(21) Appl. No.: 15/423,926

(22) Filed: Feb. 3, 2017

(51) Int. Cl. G06Q 30/06

(52) U.S. Cl. CPC G06Q 30/0635; G06Q 30/0641

(57) ABSTRACT

A system for enhancing shopping in a physical shopping environment including multiple products is provided. The system may include a computing device positioned in the physical shopping environment having a display that activates when a shopper is detected in a specified vicinity of the display. When activated, the display is configured to display a subset of products based on visibility metrics for products in the physical shopping environment and products related to the products in the physical shopping environment that indicate a relative degree to which shopper eyes focused on the products during a product visibility analysis phase prior to the shopping phase. The input device is configured to receive a shopper selection associated with at least one of the products displayed, and a processor of the computing device is configured to perform a predetermined action associated with a selected product in response to receiving the shopper selection.

### BACKGROUND

A tension exists for retailers when determining what products to offer and where to offer them in a retail environment. A retailer might choose to offer a large number of products; however, this increases the size and cost of the store and products with lower volume of sales may yield diminished returns. A retailer might choose to offer only a smaller number of high volume products, but shoppers might not choose to shop at such a store because a wide selection of products isn't offered. Colloquially, the best-selling products are often referred to as the “big head” while products that sell in lower volumes are referred to as the “long tail.” While many customers purchase so called “big head” products, the particular products within the long tail sought by each individual shopper are quite diverse. Thus, it is difficult for retailers to select a subset of the big head and long tail products to offer in stores that improves both customer satisfaction and the economic performance of the store.

### SUMMARY

To address the above issues, a system for enhancing shopping in a physical shopping environment including multiple products that may be in multiple physical locations is provided. The system may include a computing device positioned in the physical shopping environment having a display that activates when a shopper is detected in a specified vicinity of the display. When activated, the display is configured to display a subset of products based on visibility metrics for products in the physical shopping environment and products related to the products in the physical shopping environment that indicate a relative degree to which shopper eyes focused on the products during a product visibility analysis phase prior to the shopping phase. The input device is configured to receive a shopper selection associated with at least one of the products displayed, and a processor of the computing device is configured to perform a predetermined action associated with a selected product in response to receiving the shopper selection.

The system may further include an eye focus measuring device configured during the product visibility analysis phase to record eye focus data for product exposure of one or more products to one or more shoppers in the physical shopping environment. The processor may be further configured during the product visibility analysis phase to analyze the measured eye focus data and generate data indicating for each product of the multiple products, the visibility metric for the product from a share of shoppers that were measured as focusing their gaze on the respective product and its attributes in the physical shopping environment.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The present disclosure is illustrated by way of example and not by way of limitation in the figures of the accompanying drawings, in which the like reference numerals indicate like elements and in which:

FIG. 1 is a schematic depiction of an example system for enhancing shopping in a physical shopping environment, according to one embodiment of the present disclosure;

FIG. 2 is a schematic depiction of products and a shopper located at respective positions relative to each other in an aisle of the physical shopping environment of the system of FIG. 1;

FIG. 3 is schematic diagram of the system of FIG. 1, illustrating example variables measured in a product visibility analysis phase in the physical shopping environment, which are used in the formulation of a visibility metric for each product; and

FIG. 4 is a flowchart of a method for an interactive shopping system according to one embodiment of the present disclosure.

### DETAILED DESCRIPTION

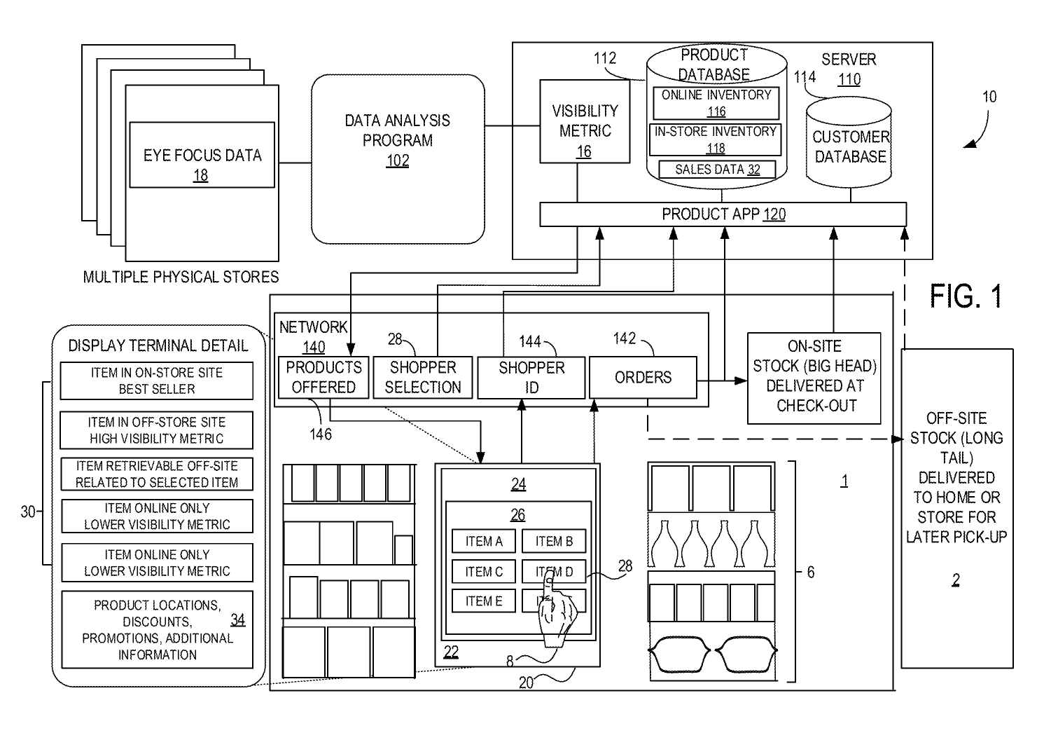

Systems and methods for employing product visibility data to strategies for big head and long tail sales in a physical shopping environment are disclosed herein. FIG. 1 schematically shows a physical shopping environment 1 including multiple products 6 where shoppers 8 are present. One product may be present in multiple locations in the store. It will be appreciated that the physical shopping environment may be, for example, a physical building serving as a retail location in which various products 6 are offered for sale. Example physical merchant stores include supermarkets, convenience stores, clothing retailers, department stores, hardware stores, restaurants, bazaars, malls, etc.

With reference to FIG. 1, a system 10 for enhancing shopping in a physical shopping environment 1 including multiple products 6 is provided. An interactive computing device 20 positioned in the physical shopping environment may be configured with a display terminal 22 having a display 24 that is configured to activate during a shopping phase when a shopper 8 is detected in a specified vicinity of the display 22.

The display 24 is configured to display a subset of products 30 based on a visibility metric 16 for products 6 in the physical shopping environment 1 and products related to the products 6 in the physical shopping environment 1. An input device 26, such as a touch sensor, of the display 24, or a button, keyboard or mouse of the associated computing device 20, for example, may be configured to receive a shopper selection 28 associated with at least one of the products 30 displayed on the display 24. The shopper selection 28 may include a product for purchase, an inquiry of an item, promotional content, or other interactive options on the display 24. Products for purchase may be available within the physical shopping environment 1, may be retrievable from an off-site location 2 such as a distribution center, or may be available online only. The shopper 8 may obtain a purchase immediately by way of an order 142 should the product be directly accessible, for example on a shelf or in an inventory storage location within the physical shopping environment 1. Alternatively, the purchase may be delivered either to the physical shopping environment 1 at a later time or directly to an external address.

Prior to the shopper selection 28, the display 24 may display a subset of products 30 based on sales data 32 for the physical shopping environment 1 or a related physical shopping environment. Furthermore, promotions, discounts, product locations, or additional information 34 may be displayed on the display 24 before the shopper selection 28, which may be based on the visibility metric 16. Sales data 32 may also be used to determine what additional information 34 is displayed on the display 24.

As one particular use case scenario, consider a retail chain that offers two sizes of retail store: a larger store that offers a very large selection (i.e., big head and long tail) of groceries and assorted household goods, and a compact store that offers only the best selling products in store but also features computing devices 20 of the system 10. In such a case the retail chain may choose to configure the computing devices 20 to display products on the displays 24 in the compact store that are not in the inventory of the compact store, but which are offered for home delivery, perhaps fulfilled from the inventory of the nearby larger store. Specifically, a display in the salty snacks aisle of the compact store may be configured to display the 10 (or other number of) most often viewed products in the salty snacks aisle of the larger store which are not offered on-premises in the compact store, based on visibility metrics from the larger store. Similar arrangements can be made for other sections or departments in the compact store, such that the most viewed products in a corresponding section of the larger store which are not in in-store inventory of the compact store are offered to the user via display 24 when the user approaches the display. Further, if the user's desired product is not immediately displayed as the user approaches the display 24, affordances can be made for the user to scroll through a long tail inventory list, filtered for the corresponding section of the store and sorted in descending order by the visibility metric, using the display 24, until a desired product is found.

The display of products on display 24 may further be customized based on user interactions with the display 24. Thus, as a result of the shopper selection 28, a predetermined action associated with a selected product may follow and new options may be displayed on the display 24 to the shopper 8. The predetermined action following the shopper selection 28 may include display of recommended shopper-specific products. Prior to the shopper selection 28, the display 24 may be configured to offer promotions and additional information 34 that are not customized for any selected product or to a particular shopper 8, but rather are filtered and sorted in a list as described above, for example. However, once a shopper 8 makes a shopper selection 28, the subset of products 30 that repopulate the display 24 may be based on the product selected by the shopper 8. A user selection of a cheese flavored salty snack may cause the list to repopulate with other cheese flavored snacks, or other products purchased by shoppers who purchase the selected cheese flavored snack, for example.

Furthermore, the shopper may provide a personal shopper ID 144 to the display terminal 22 by way of the input device 26, scanning device, or other information gathering device that garners shopper-specific information from the shopper such as purchase history, product preferences, and other retail relevant data. Therefore, for example, a purchase history of the shopper may be used in the recommendation of shopper-specific products to the shopper 8 selecting a product on the display terminal 22. The visibility metric 16 of the products 6 or sales data 32 for the physical shopping environment 1 may also be utilized in the determination of the subset of products 30 that are shopper-specific and displayed on the display terminal 22 after a shopper selection 28. In this way, the list of products may not only be filtered by store section and sorted by descending order of visibility metric, but may also be filtered to only include products that were prior purchased by the particular shopper.

Additionally, the predetermined action following the shopper selection 28 may include an updated display of promotions and additional information 34. The specificity of this information may also be augmented based on the shopper selection 28, the visibility metric 16 of the products 6, shopper-specific information or sales data 32 for the physical shopping environment 1.

It will be appreciated that data garnered from the interaction of the shopper 8 with display terminal 22 can be utilized by retailers in the formulation of shopping management strategies and customization of the shopping experience. In particular, selling big head or long tail products to shoppers may be made more effective through the use of shopper-specific information analyzed for and applied to the scope of a particular retailer. To that end, shopper selections 28 made at the display terminal 22 may be analyzed to provide data for optimizing stocking the physical shopping environment 1 with products 6. Furthermore, this data may be used as a feedback, incorporated into the determination of products to be featured on the display terminal 22 in the physical shopping environment 1 to shoppers in general; this may include products displayed initially on the display terminal 22 before a shopper selection 26 or the recommendations made after a shopper selection 28.

An additional component of the display terminal 22 may include a camera or other recording device. This device may record or monitor shopper behavior, movement, or interaction with the display terminal 22 or products 6 or other displays in the vicinity of the display terminal 22. Data gathered by these means may be used as feedback into the system 10, for example to construct visibility metric 16 or the display of a subset of products 30 on the display 24 or to produce other informative analysis for the retailer. An example implementation of a monitoring device is an infrared camera that may be used to track the gaze of shoppers 8. Alternatively, management of multiple products 6 in the physical shopping environment 1 may follow the recording and analysis of shopper interaction with multiple products 6 present on shelves in the vicinity of the display terminal 22 from where shopper behavior may be monitored.

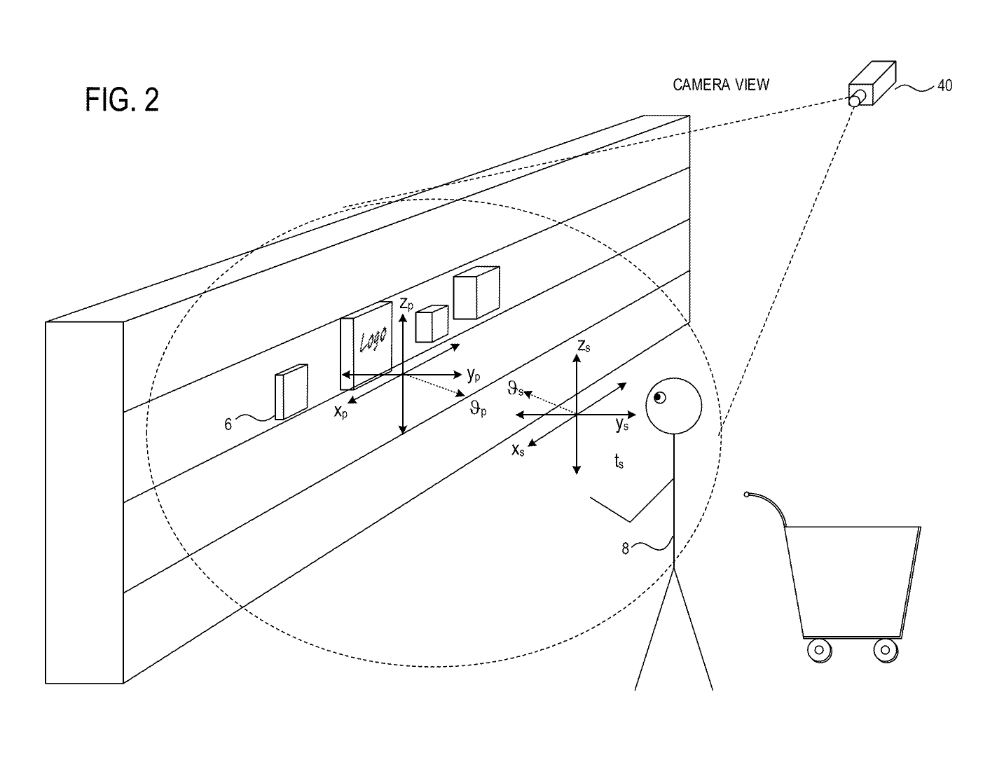

Prior to the shopping phase, a product visibility analysis phase may take place where the visibility metric 16 is constructed to be later used during the shopping phase. The visibility metric 16 indicates a relative degree to which shopper eyes focused on the products 6 during a product visibility analysis phase, as shown in FIG. 2. A recording device 40 records eye focus data 18 for product exposure of one or more products 6 to one or more shoppers 8 in the physical shopping environment 1. It will be appreciated that the recording of eye focus 18 data may be conducted by human observers, digital recording devices, or other suitable means.

A video recording, while continuously documenting shoppers 8, can be searched for a sampling of images from which the eye focus data 18 of shoppers 8 can be obtained. Still images may also be used, the images recorded when a device such as a camera is triggered by an event that may include a shopper 8 entering the viewing region and activating a sensor. Human observers may also report directly a sampling of shopper behavior observed and manually recorded within the physical shopping environment 1. A significant amount of sampling utilizing still images or human observers may approach the data gathering potential of video recording, in spite of not being continuous.

Using a video recording to analyze shopper behavior may employ any number of appropriate methods for subsequent analysis. Screen locations of shoppers 8 may be expressed in a coordinate system or in terms of pixel location and stored. The coordinate system may then be translated into a store location, possibly using a map or other system. Reconstruction of a shopping trip of a shopper 8 or identification of purchase event points within the physical shopping environment 1 may be gained from the analysis. Associating this information with store displays and product locations, as well as potentially with shopper demographics, may be used in construction of visibility metric 16 or a richer analysis of the retail environment.

Various methods may be employed to measure eye focus data 18 and construct the visibility metric 16. Recognition of a pre-purchase event, tracking subsequent movement of a focus position of a shopper 8, and recording a purchase event may be included in the method. The purchase event may be deconstructed based on the movement of the focus position and related to products, logos, or other features in the location of the focus position of the shopper 8 for durations that may be above a particular threshold. Deconstruction of the shopping events may lead to a product region in the physical shopping environment 1 being associated with sales data and units representing spending.

In one implementation, a record of the amount of time that a product location is in an estimated field of view for a shopper 8 may be made. The measured eye focus data 18 may then be analyzed to generate data that indicates, for each product of the multiple products 6, the visibility metric 16 for a specific product. The visibility metric 16 may be derived from a share of shoppers 8 that were measured as focusing their gaze on the respective product and its attributes in the physical shopping environment 1. Additionally, the visibility metric 16 may be based on other visual attributes associated with the products 6, such as logos, sales tags, or other product information. A visibility metric 16 may include the amount or percentage of time that a specific product or product location is within the field of view of the shopper 8. Alternatively, a percentage of shoppers 8 that have a field of view in which the product location lies may be included in the visibility metric 16.

Information included in the visibility metric 16 may be characteristic of the products 6 or the shopper 8, or other factors determined to be relevant to the visibility metric 16. As shown in FIG. 2, a physical location may be determined or estimated for the eyes of the shopper 8 and represented by the variables xₛ, yₛ, zₛ, where the focus of the eyes is represented by vₛ. The time during which the shopper 8 has an estimated field of view on a particular product, for example, may be tₛ. Similarly, the physical location of the product may be represented by the variables xₚ, yₚ, zₚ, the direction the product faces represented by vₚ. The time over which a particular product remains on the shelf may be given by tₚ. Both sets of variables may be utilized in the calculation of a visibility metric.

Periodic measurement of shoppers 8 in physical shopping environment 1 may include time measures for total shopper investment in the physical shopping environment 1, the distribution of time attributed to shoppers 8 interacting with products 6, and associated sales. A substantial sample of physical shopping environments 1 provides the data for mathematical analysis resulting in the visibility metric 16. The whole of the data represents the sum of analysis of individual shoppers 8, as the visibility metric 16 is inextricably tied to individual shopper behavior and not to breaking the physical shopping environment 1 into a top-down analysis. This achieves the potential advantage of product flow remaining shopper-relevant.

Prior art relevant to the system and method is discussed below. It will be appreciated that the prior art may serve to enhance the method and system provided.

In US20130132241A1 (Imputed probabilistic product location based on shopper path and transaction log data), the entire disclosure of which is herein incorporated by reference, a sensor system is used to track paths of shoppers 8 in a physical shopping environment 1. Signal data from the sensor system tracking shoppers 8 coupled with point-of-sale transaction data may be combined to associate a product 6 with a plurality of shopper paths in the physical shopping environment 1. This medium of shopper-product tracking may be supplemental to the generation of a visibility metric 16.

U.S. Pat. No. 9,076,149B2 (Shopper view tracking and analysis system and method) and U.S. Pat. No. 9,483,773B2 (Point of view shopper camera system with orientation sensor), the entire disclosures of each of which are herein incorporated by reference, provide a method to generate and analyze shopper view data in a physical shopping environment 1. A head device with an eye camera and head orientation sensor accompanied by a tracking sensor provide physical data on the shopper 8 to be analyzed, resulting in an estimated field of view of a shopper 8. Although impractical to implement on a large scale, this device and method may be used to provide at least in part data for calculation of a visibility metric 16.

Further detail may be obtained for visibility metric calculation by way of the methods taught in U.S. Pat. No. 8,873,794B2 (Still image shopping event monitoring and analysis system and method), the entire disclosure of which is herein incorporated by reference. A still image may be analyzed to discern events where shoppers 8 only visit or stop to shop in locations of a physical shopping environment 1. This type of analysis may strengthen the value of the visibility metric 16 assigned to various products 8.

Shopper behavior analysis techniques provided in U.S. Pat. No. 8,140,378B2 (System and method for modeling shopping behavior) combined with methods and in U.S. Pat. No. 8,041,590B2 (In-store media rating system and method) and the device in U.S. Pat. No. 7,944,358B2 (Traffic and population counting device system and method) allow for the monitoring of shopper traffic in terms of frequency or length of shopper visits in a specific vicinity of a physical shopping environment 1; analysis-based grids and shopping zone monitoring may be utilized. The entire disclosures of each of these applications are herein incorporated by reference. Statistical computations based on these measurements may yield quantitative information on shopper visits, purchases, buy time, and related values based on product positions and shopper paths, all of which may be monitored for the determination of visibility metric 16 and the subset of products 30 that are featured on a display 24 to shoppers 8.

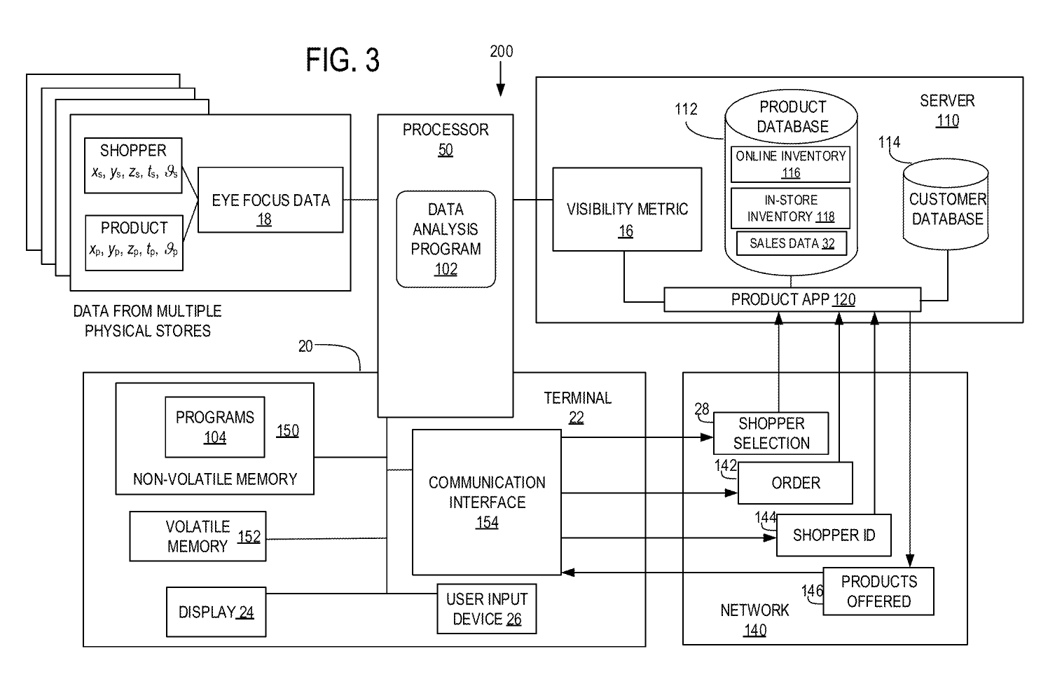

A computer system 200 as illustrated in FIG. 3 provides the computing hardware and software infrastructure for a system 10 enhancing shopping in a physical shopping environment 1 including multiple products 6. Data collected in the product visibility analysis phase may comprise eye focus data 18; this data may be gathered at multiple physical stores. A processor 50, as detailed in FIG. 3, may be configured to execute various programs as required by the system 10. The processor 50 may include data analysis programs 102 that may be configured to analyze the measured eye focus data 18 and generate data indicating the visibility metric 16.

A server 110 may include the visibility metric 16, a product database 112, and a customer database 114. The product database 112 may include online inventory 116, in-store inventory 118, and sales data 32. The data located on the server may be used to populate display 24 of display terminal 22 in a physical shopping environment 1 via a network 140 by way of a product application 120 with a subset of products 30, promotions, and additional information 34, which have been filtered and sorted as described above. Likewise, shopper selections 28 may be stored on the server 110, providing feedback data to the online inventory 116, in-store inventory 118, and storing sales data 32. The customer database 114 may store personal shopper IDs 144 that may factor into the population of display terminal 22 with recommended shopper-specific products, promotions, and additional information 34

The network 140 may function to connect the server 110 with the display terminal 22. The shopper selection 28, order 142 placed by a shopper 8, shopper ID 144, and products offered 146 on the display terminal 22 be linked between the server 110 and the interactive device 20 with the display terminal 22 through the network 140. Products offered 146 may include the subset of products 30 displayed on the display terminal 22 before or after the shopper selection 28 and other products or information as determined by the retailer. The processor 50 may be additionally configured to perform the predetermined action associated with a selected product in response to receiving the shopper selection 28 on the display 24 of display terminal 22.

The processor 50 may be connected to non-volatile memory 150 that may also store programs 104 as required by the system 10. A volatile memory 152 (e.g., RAM) may also connect to the processor 50 and non-volatile memory 150 (e.g., flash memory, hard drive, ROM, etc.). At the display terminal 22, the display 24 and input device 26 may also be present as components; these may be additionally connected to the processor 50 and memory components 150 and 152. A communication interface 154 may be linked by a communications bus to a processor 50 and other components of the interactive device 22. The communication interface 154 is typically configured to connect the network 140 to link the interactive device 20 and the server 110.

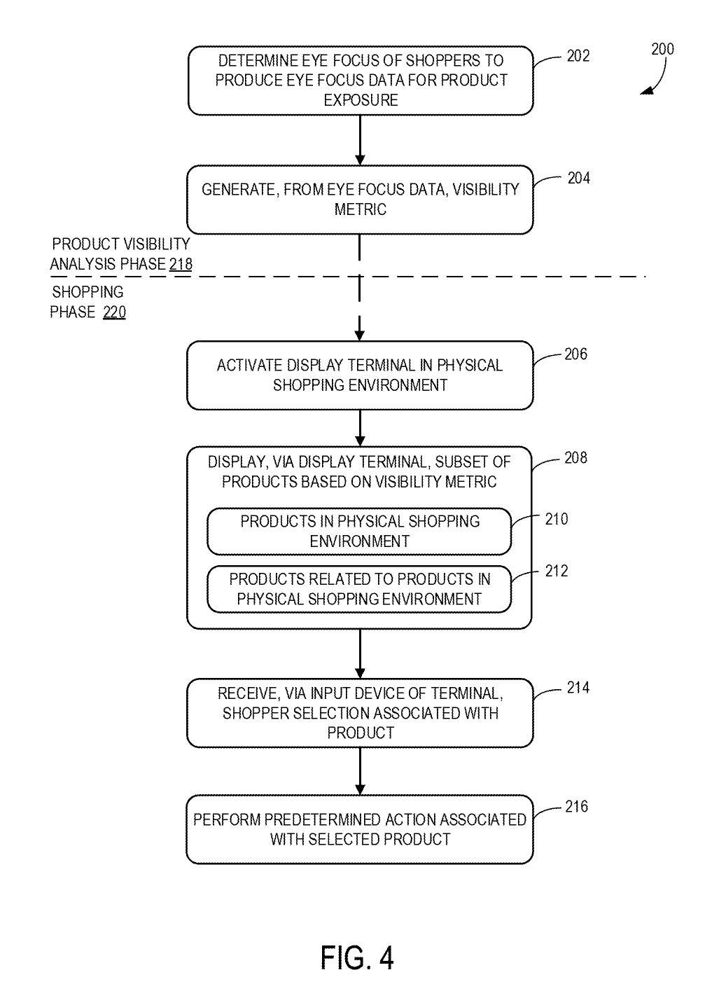

FIG. 4 illustrates a method 200 for enhancing shopping in a physical shopping environment 1 including multiple products 6. Method 200 may be executed using the hardware of system 10 describe above, or using other suitable hardware. At 202, in a product visibility analysis phase 218, the method includes determining the eye focus of shoppers 8 by observation of the shoppers 8 in the physical shopping environment 1 to produce eye focus data 18 for product exposure of one or more products 6 to one or more shoppers 8 in the physical shopping environment 1. At 204, also in product visibility analysis phase 218, the method further includes generating, from eye focus data 18, a visibility metric 16. The eye focus data 18 may be for any number of products 6. A number of various methods to quantify the visibility metric 16 may be used. For example, the visibility metric 16 may include a percentage of shoppers 8 that were measured as having an estimated field of view on a product location or the product's attributes in the physical shopping environment 1; alternatively, the amount of time over which shoppers 8 were measured to focus on a product location or the product's attributes in the physical shopping environment 1 may comprise the visibility metric 16.

In a shopping phase 220, the method at 206 further includes activating a display terminal 22 in a physical shopping environment 1. The activation may be caused when a shopper 8 is detected in a specified vicinity of the display terminal 22. At 208, the method further includes displaying, via a display 24 on display terminal 22, a subset of products 30 based on the visibility metric 16. At 210, the method may include the generating the visibility metric 16 for products 6 physically located in the physical shopping environment 1 or a related physical shopping environment (i.e., another store). The method at 212 may include generating the visibility metric 16 based upon for products related to the products 6 in the physical shopping environment 1 or a related physical shopping environment. As discussed above, the visibility metric 16 may indicate a relative degree to which shopper eyes focused on the products during product visibility analysis phase 218.

The method at 214 further includes receiving, via an input device 26 of the terminal, a shopper selection 28 associated with at least one of the products 30 displayed. The input device 26 may be, for example, a touch screen device. At 216, the method further includes performing a predetermined action associated with a selected product in response to receiving the shopper selection 28. This may include new options displayed on the display terminal 22 to the shopper 8 as described above, encompassing recommended shopper-specific products, promotions or additional information 34, or other displayed data.

As described above, a subset of products 30 may be displayed via the display 24 before the shopper selection 28. These items may be based on sales data 32 for the physical shopping environment 1. Promotions or additional information 34 may also be displayed via the display terminal 22 before the shopper selection 28 that are based on the visibility metric 16 or sales data 32. After the shopper selection 28, the predetermined action may take the form of displaying recommended shopper-specific products to the shopper 8 selecting a product on the display 24. The recommended shopper-specific products may be populated by items based on the shopper selection 28, visibility metric 16, shopper-specific information as provided by the supplying of a personal shopper ID 144 by shopper 8 via an input device 26 associated with the display 24, or sales data 32. Similarly, display of promotions or additional information 34 may be displayed on the display 24 after the shopper selection 28 based on the shopper selection 28, the visibility metric 16, shopper-specific information recalled from a shopper ID 144 when available, or sales data 32.

On the basis of shopper selections 28, data may be provided and analyzed to inform the stocking of the physical shopping environment 1. At the display terminal 22 in the physical shopping environment 1, data from shopper selections 28 may be used as feedback to feature products on the display 24 to shopper 8, as described above.

In one exemplary embodiment, the method may entail a sequence associating individual shopper behavior with product flow. In a first step, shopper focus is measured with variables xₛ, yₛ, zₛ, vₛ, and tₛ. Variables xₚ, yₚ, zₚ, vₚ, tₚ are also measured and associated with the shopper focus variables. In a second step, shopper behavior of many shoppers is combined to yield a statistical table with numerical values representing exposure for each location based on shopper viewing in the physical shopping environment 1. In a third step, products are identified by planogram data, auditing, photos, or the previously measured variables. In a fourth step, sales data from transaction logs is associated with planogram data, product data, and shopper viewing data to calculate an efficiency for exposure in relation to sales. In a fifth step, the physical shopping environment data is used to connect the physical shopping environment 1 with off-site and online purchases through the display terminal 22 or other computing device accessible to the shopper 8.

The system 10 as described above provides the structure for retailers to form effective sales strategies, in particular for offering both big head products and long tail products to shoppers. Retailers wishing to customize the shopping experience will be able to do so by employing observations from shoppers 8 in the formulation of a visibility metric 16 that makes the specialization of product offerings through display terminal 22 possible. In return, feedback from shopper selections 28 can be used to refine product offerings and further streamline the customization of the shopping experience, as it is effectively tuned to shopper preferences.

The physical shopping environment 1 is therefore enhanced in terms of stock, inventory, and space, while additional products are functionally available through off-site and online sources. Using these systems and methods a retailer may provision a compact store with best-selling products, and may provide computing devices in the compact store that display products not in inventory at the compact store which are often viewed by shoppers at other larger stores. These results may be filtered by section of store, shopping history of the shopper, selections made by the shopper on the device, and sorted in descending order by the degree of visibility (i.e., the visibility metric). Doing so increases the relevance of what is displayed to the shopper in the compact store, and enables the shopper to conveniently purchase products not in inventory. Maintaining a visibility metric tied to individual shopper behavior avoids breaking the physical shopping environment 1 into a top-down analysis and product flow remains shopper-relevant. Compact store architecture supplemented by the technology of the present disclosure may result in increased cost savings and convenience to both the retailer and user.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A system for enhancing shopping in a physical shopping environment including multiple products, the system comprising:
a computing device positioned in the physical shopping environment, the computing device having a display that activates during a shopping phase when a shopper is detected in a specified vicinity of the display, the display when activated being configured to display a subset of products based on visibility metrics for products in the physical shopping environment and products related to the products in the physical shopping environment that indicate a relative degree to which shopper eyes focused on the products during a product visibility analysis phase prior to the shopping phase;
an input device configured to receive a shopper selection associated with at least one of the products displayed; and
a processor configured to perform a predetermined action associated with a selected product in response to receiving the shopper selection.

2. The system of claim 1, further comprising:
an eye focus measuring device configured during the product visibility analysis phase to record eye focus data for product exposure of one or more products to one or more shoppers in the physical shopping environment; and
the processor being configured during the product visibility analysis phase to analyze the measured eye focus data and generate data indicating for each product of the multiple products, the visibility metric for the product from a share of shoppers that were measured as focusing their gaze on the respective product and its attributes in the physical shopping environment.

3. The system of claim 1, wherein the display is configured to display a subset of products before the shopper selection based on sales data for the physical shopping environment.

4. The system of claim 1, wherein the display is configured to display promotions before the shopper selection based on data selected from the group consisting of the visibility metrics of the products displayed and sales data for the physical shopping environment.

5. The system of claim 1, wherein the predetermined action includes display of recommended shopper-specific products to a shopper selecting a product on the display terminal, wherein the recommended shopper-specific products are based on a parameter selected from the group consisting of the shopper selection associated with at least one of the products displayed, the visibility metric of the products displayed, a purchase history of the shopper, and sales data for the physical shopping environment.

6. The system of claim 1, wherein the predetermined action includes a display of promotions to the shopper selecting a product on the display terminal, wherein the promotions are based on a parameter selected from the group consisting of the shopper selection associated with at least one of the products displayed, the visibility metric of the products displayed, the purchase history of the shopper, and sales data for the physical shopping environment.

7. The system of claim 1, wherein the processor of the computing device is further configured to analyze the shopper selections to provide data for stocking of the physical shopping environment.

8. The system of claim 1, wherein the processor of the computing device is further configured to analyze the shopper selections to provide data for featuring products on the display terminal in the physical shopping environment.

9. A method for enhancing shopping in a physical shopping environment including multiple products, the method comprising:
in a shopping phase:
activating a display of a computing device in the physical shopping environment when a shopper is detected in a specified vicinity of the display;
displaying, via the display, a subset of products based on a visibility metric for products in the physical shopping environment and products related to the products in the physical shopping environment that indicates a relative degree to which shopper eyes focused on the products during a product visibility analysis phase prior to the shopping phase;
receiving, via an input device of the display, a shopper selection associated with at least one of the products displayed; and
performing a predetermined action associated with a selected product in response to receiving the shopper selection.

10. The method of claim 9, further comprising:
in the product visibility analysis phase:
determining eye focus of shoppers by observation of the shoppers in the physical shopping environment to produce eye focus data for product exposure of one or more products to one or more shoppers in the physical shopping environment; and
generating from the determined eye focus data, for each product of the multiple products, the visibility metric for the product from a share of shoppers that were measured as focusing their gaze on the respective product and its attributes in the physical shopping environment.

11. The method of claim 9, further comprising displaying via the display a subset of products before the shopper selection based on sales data for the physical shopping environment.

12. The method of claim 9, further comprising displaying via the display promotions before the shopper selection based on data selected from the group consisting of the visibility metric of the products displayed and sales data for the physical shopping environment.

13. The method of claim 9, wherein the predetermined action includes display of recommended shopper-specific products to a shopper selecting a product on the display terminal, wherein the recommended shopper-specific products are based on a parameter selected from the group consisting of the shopper selection associated with at least one of the products displayed, the visibility metric of the products displayed, a purchase history of the shopper, and sales data for the physical shopping environment.

14. The method of claim 9, wherein the predetermined action includes a display of promotions to the shopper selecting a product on the display terminal, wherein the promotions are based on a parameter selected from the group consisting of the shopper selection associated with at least one of the products displayed, the visibility metric of the products displayed, the purchase history of the shopper, and sales data for the physical shopping environment.

15. The method of claim 9, further comprising, at the display terminal, analyzing the shopper selections to provide data for stocking of the physical shopping environment.

16. The method of claim 9, further comprising, at the display terminal, analyzing the shopper selections to provide data for featuring products on the display terminal in the physical shopping environment.
